(19) United States
(12) Patent Application Publication
(10) Pub. No.: US 2005/0226473 A1
(43) Pub. Date: Oct. 13, 2005

(54) Electronic Documents Signing and Compliance Monitoring Invention

(76) Inventor: Subramanyan Ramesh, Redondo Beach, CA (US)

Correspondence Address: S. Ramesh, 1874 S. Pacific Coast Highway, #722, Redondo Beach, CA, 90277, US

(21) Appl. No.: 10/907,610

(22) Filed: Apr. 7, 2005

Related U.S. Application Data
(60) Provisional application No. 60/521,349, filed on Apr. 7, 2004.

(51) Int. Cl. G06K 9/00

(52) U.S. Cl. 382/119

(57) ABSTRACT

The invention enables the creation of digital originals of signed documents. Digital originals documents are managed within document sets, which may be used to store all of the documents that are required to fulfill one business purpose (such as a mortgage closing). Document sets may be encrypted, may provide meta information so that they may be indexed, managed and archived, may be versioned, and may have states. Document sets may have meta information specifying the states that they can achieve, and the rules, which specify the required characteristics (including required documents or types of documents, required signatures, required signatories or signer roles, etc.) of document sets to enter each states.

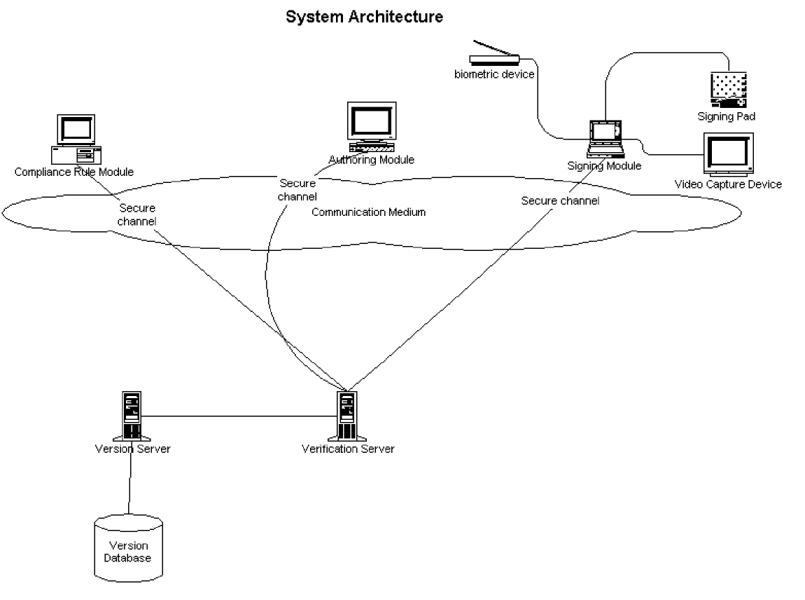

The invention enables the creation of digital originals of signed documents. Digital originals documents are managed within document sets, which may be used to store all of the documents that are required to fulfill one business purpose (such as a mortgage closing). Document sets may be encrypted, may provide meta information so that they may be indexed, managed and archived, may be versioned, and may have states. Document sets may have meta information specifying the states that they can achieve, and the rules, which specify the required characteristics (including required documents or types of documents, required signatures, required signatories or signer roles, etc.) of document sets to enter each state.

The electronic documents can be signed digitally by the use of any sort of image capture technology/signature capture technology or optionally without the need for image capture and signature capture technology. The electronic signatures may be bound to the electronic documents using any type of encryption or digital signature technology, including but not limited to any algorithm enabling symmetric and/or public/private (PKI) encryption. Each document original may be signed by one or more signers, in one or more spots on the document. Signatures may be each individually captured at each signature point, or a single capture may be used, with a programmatic method to verify acceptance, to apply a single signature to multiple points on a single document, and other documents within that document set.

Electronic signatures are composed of many elements, optionally including one or more of the following elements:
Image and other information captured from the act of signing on any type of electronic device that can capture such a signature, including electronic signature pads; notepads, notebook computers, mouse or other input devices, graphics tablets, or any devices existing, or that may be developed, that can record the act of signing, including the image of the signature thereby generated, video or photographic capture of the actual act of signing, and any information about such signing (such as pressure, speed, direction and inclination of the signing device, etc.).
Personal information of the signer, including name, address, and other required information.
One or more recorded instances of authenticating the signer, by any method developed or that may be developed to authenticate an individual including: biometric authentication (such as fingerprint or palm scan, iris scan, facial recognition, voice recognition, “active” signature (deriving biometric authentication from the act of signing), DNA scanning, or any other biometric method currently developed or that will be developed in the future); smart cards or any other type of personal identification card or device; photographic or video images of the signer; dongles or any other digital device used to authenticate an individual; public/private key or symmetric key possession; passwords; pass phrases and other means using information known by the signer; and authentication by an authorized agent.
Records of all instances of manual or offline identification methods used by authorized agents such as attorneys or notaries, such as photos, videos, or recorded numbers of personal identification such as passports and driver's license. Each instance of offline/manual identification may also include all authentication methods used to verify the authenticity and authorization of the authorized agents themselves.
Purpose of signature and other information surrounding the ceremonial and business intentions of signing.
Date of signature as recorded by the signer.
Date of signature as recorded by the software on the client and/or server modules.
Document version
Distillation of the document contents
Position within the document at which the signature is placed
Electronic sequence of events prior to and during the capture of the signature, including recording the examination of documents by the signer prior to signing, and the recording of any questions or clarifications provided prior to signing.
Multi-media captures of relevance to the signed originals, including photographic, voice, or video capture of signatories, identification documents or other signs and authorization from parties to the document, avowals or agreements to terms, or captures of the actual signing process.
Session information on the activities that occurred on each invocation of the application with a specific document set, including changes to documents, rules, meta information, signatures, signatories, and authentication instances.

Electronic documents are archived and managed within document sets. Document sets contain one or more electronic document originals. Document sets may be encrypted and signed with any encryption technology, including any symmetric encryption and public key (PKI) technology, or any combination of such technologies, including techniques that may be invented in the future to encrypt and/or sign digital files or digital streams.

Document sets can be filed, indexed, stored, archived, and accessed in any way in which digital files can be filed, indexed, stored, archived or accessed. The invention includes a method for archiving, searching, indexing, and managing document sets and the documents within them. Archival information concerning a document set can also made available to other programs that manage documents, in any form, format, or protocol that has been invented or that may be developed to exchange meta information or actual information about electronic files and documents. Such methods can include XML, Web Services, SOAP, RPC, ODBC, and any other data exchange, application integration, or remote program invocation format or technology. Meta information may provided in both encrypted and non-encrypted forms, supporting any existing or future data exchange, application integration, or remote application invocation format, and may be digitally signed, whether encrypted or not encrypted.

Document sets may undergo changes in state. Documents within document set states may also undergo changes in state, and the state of the document set may be derived from the states of its component documents, or it may be set explicitly.

The states that are available for document sets may be customized to the business processes which the document sets support, and to the required states of the creators of the document sets. Document set states can be made to fit into existing or new work flow specifications within a business. Document set states may be used for automated performance of various functions in the set of integrated systems in which the electronic signing solution is deployed.

Document sets may contain meta information on the states that they can support. Document sets always support two virtual states of “In Progress” and “Completed”. Version control can be maintained on document sets that are “In Progress”, so that when these sets are changed, the changed versions are assigned unique version identifiers. The invention includes the ability to revert to earlier version of document sets, and the ability to branch and create new versions of document from any existing version. The invention contains modules that allow users to update their document set to the latest version, a specific version, or a version as described by characteristics that are defined in the supported states of the document set.

Compliance rules can be created and applied to document sets using the user interface supplied by the invention, or by using any other user interface that allows a user to edit the meta information in a document set. A document set can be queried within the client module of the invention to verify if the document set meets the required rules that allow it to be moved to another state, including the state of “Completed”. These compliance rules may be independently edited for each document set, or they may use document roles and signer roles to define compliance scenarios for document sets to complete specific business processes.

1. A method whereby whereby one or more electronic documents or contracts are signed on an electronic device by one or more signers, so that the signed originals are also electronic documents.

2. The method as recited in claim 1 where the signature on the electronic documents are composed of digital keys that are in the possession of the signers, or of third parties such as notaries or lawyers who enable electronic signing.

3. The method as recited in claim 1 where the signature on the electronic documents include image and other information captured from the act of signing on any type of electronic device that can capture such a signature, including electronic signature pads; notepads, notebook computers, mouse or other input devices, graphics tablets, or any devices existing, or that may be developed, that can record the act of signing, including the image of the signature thereby generated, video or photographic capture of the actual act of signing, and any information about such signing (such as pressure, speed, direction and inclination of the signing device, etc.).

4. The method as recited in claim 1 where the signature on the electronic documents include personal information of the signer, including name, address, and any other gathered information.

5. The method as recited in claim 1 where the signature on the electronic documents include one or more recorded instances of authenticating the signer, by any method developed or that may be developed to authenticate an individual including: biometric authentication (such as fingerprint or palm scan, iris scan, facial recognition, voice recognition, “active” signature (deriving biometric authentication from the act of signing), DNA scanning, or any other biometric method currently developed or that will be developed in the future); smart cards or any other type of personal identification card or device; photographic or video images of the signer; dongles or any other digital device used to authenticate an individual; public/private key or symmetric key possession; passwords; pass phrases and other means using information known by the signer; and authentication by an authorized agent.

6. The method as recited in claim 1 where the signature on the electronic documents include records of any instances of manual or offline identification methods used by authorized agents such as attorneys or notaries, such as photos, videos, or recorded numbers of personal identification such as passports and driver's license. Each instance of offline/manual identification may also include all authentication methods used to verify the authenticity and authorization of the authorized agents themselves

7. The method as recited in claim 1 where the signature on the electronic documents include purpose of signature and other information surrounding the ceremonial and business intentions of signing.

8. The method as recited in claim 1 where the signature on the electronic documents include the date of signature as recorded by any signer, either explicitly, or implicitly by the system.

9. The method as recited in claim 1, wherein any changes to the written content of any document disables the signatures that were on that document.

10. The method as recited in claim 1, wherein a group of documents may be placed into an electronic container, and the documents within that container may be signed so that the signed originals are electronic documents within the electronic container.

11. The method as recited in claim 10 where rules may be set for the electronic container, conerning any details of the signing process, including which documents must be included within the container, those persons who are required to sign each document, or at each place within a document.

12. The method as recited in claim 11 where rules of a container are optionally enforced, or optionally recommended to the participants, during the process of signing the documents.

13. The method as recited in claim 11 where the container or the documents within a container may go through different states, and such states can change the process or be reported during the signing process.

14. The method as recited in claim 13 where the states that are possible for a container or the documents within a container may be specified and changed within the container.

15. The method as recited in claim 11 where the container or the documents within a container may be versioned individually and together.

16. The method as recited in claim 11 where the container or the documents within a container may follow a workflow during the process of creation, signing, or versioning.
